(19) United States
(12) Patent Application Publication
(10) Pub. No.: US 2009/0260355 A1
(43) Pub. Date: Oct. 22, 2009

(54) Stirling engine assembly

(76) Inventors: John Howard Alderson, Matlock (GB); David Anthony Clark, Hugglescote (GB); Julie Patricia Hyde, Meriden (GB); Heather Allderidge, Derby (GB); Jennifer Jane Lamb, Sutton Coldfield (GB)

Correspondence Address: Ballard Spahr Andrews & Ingersoll, LLP, SUITE 1000, 999 PEACHTREE STREET, ATLANTA, GA, 30309-3915, US

(21) Appl. No.: 10/514,296

(22) PCT Filed: May 14, 2003
(86) PCT No.: PCT/GB03/02080

§ 371 Date: Jan. 7, 2008

(30) Foreign Application Priority Data
May 15, 2002 (GB) 0211121.9

(51) Int. Cl. F02G 1/04

(52) U.S. Cl. 60/517

(57) ABSTRACT

A Stirling engine assembly comprising a Stirling engine (1) having a head (2). A burner (7) for providing heat to the engine head surrounds the head. A flexible seal (20) seals the interface between the engine and burner. A first liquid coolant circuit (25) is positioned between the burner and seal to reduce the heat transfer from the burner to the seal.

The present invention relates to a Stirling engine assembly, and, in particular to a Stirling engine assembly for use in a combined heat and power (chp) system primarily for use in a domestic environment.

The Stirling engine has a burner located around the heater head at the top of the engine. A problem for the Stirling engine-based chp system is the need to ensure that combustion gases do not pass downwards into the room-sealed unit enclosure, causing the accumulation of potentially harmful gases. Some form of seal is therefore required between the Stirling engine and the burner.

When operating, the Stirling engine vibrates, due to its reciprocating components. A vibration reduction system, incorporating various damping and absorbing components has brought the residual levels of vibration to a low level, but there is still enough to cause problems to any seal located between the vibrating engine and the stationary burner casing. Some conventional seal designs are typically significantly stiffer than the engine suspension system and would, if used in the application, lead to unacceptable transmission of forces between the oscillating engine and the static burner components. As such the seal design is required to be extremely robust, operate at high temperatures, and be capable of maintaining an adequate seal under all operating conditions, as defined by the gas appliance certification procedure.

Excessive wear, fatigue or degradation of such a seal would cause combustion gases to leak into the unit enclosure, causing a hazard, and increasing noise levels. A seal design is therefore required that is flexible enough to cope with the relative motion (vertical, horizontal and rotational in nature) between engine and burner. In addition, this seal must be able to withstand the high temperatures associated with the burner gases, and must not be corroded by the gases involved.

One prior art design proposed by GE in 1979 (GE Semi-Annual Report 80SD54215) uses a PTFE seal. Such a seal is not suitable in a domestic environment as it introduces a potential hazard at the temperatures involved due to known toxic emissions from PTFE.

U.S. Pat. No. 5,918,463 proposes the use of a ceramic seal. However, ceramic is a material which is susceptible to failure due to vibration.

According to the present invention a Stirling engine assembly comprises a Stirling engine having a head, a burner for providing heat to the engine head, a flexible seal between the engine and burner, and a first liquid coolant circuit between the burner and seal positioned to reduce the heat transfer from the burner to the seal.

By providing a coolant circuit, the temperature that the seal must withstand can be significantly reduced such that conventional seal materials can be used.

The liquid for the first liquid coolant circuit can be provided from any suitable source. However, the Stirling engine has a cooler with a second liquid coolant circuit. It is therefore convenient to feed the first and second liquid coolant circuits with common liquid.

With such an arrangement, the first and second liquid coolant circuits may be arranged in parallel. In this case, the flow of liquid to the first liquid coolant circuit will generally be a bleed flow from the main flow of liquid to the second coolant circuit. Alternatively, the flow to the first and second liquid coolant circuits may be arranged in series. In this case, it is preferable for the liquid to flow around the second coolant circuit prior to the first coolant circuit to maintain the cooler at as low a temperature as possible.

If the first liquid coolant circuit is positioned radially inwardly of the seal, this can increase the distance between the burner and seal and allow the seal to be positioned in a region where it is more readily cooled by the surrounding air.

In addition to the first liquid coolant circuit, it can be advantageous to provide additional ways of reducing the heat transfer from the burner to the seal. For example, a tortuous path can be provided for gas flowing from the burner to the seal. Alternatively or additionally, insulation may be provided to reduce heat transfer from the burner to the seal. Both of these objectives can be achieved by packing the space beneath the burner between a burner housing and the head of the Stirling engine with a fibrous insulating material.

The flexible seal may be any material suitable for the job. However, the invention allows the use of conventional, commercially available sealing materials which are capable of withstanding a maximum temperature of less than 350° C., such as a silicon rubber sealing material.

A further way of maintaining the seal as at low a temperature as possible is for the flexible seal to extend into the first liquid coolant circuit. This brings the coolant into direct contact with the flexible seal. Preferably, the first liquid coolant circuit has, surrounding the engine, an open annular channel section and an annular plate across the open annular section, wherein the seal is sandwiched between the channel section and plate. This allows the coolant into contact with the seal as referred to above, and also provides a way of attaching the seal to the coolant circuit, as well as sealing the coolant circuit, thereby eliminating the need for a further sealing element.

Examples of a Stirling engine assembly in accordance with the present invention will now be described with reference to the accompanying drawings, in which:

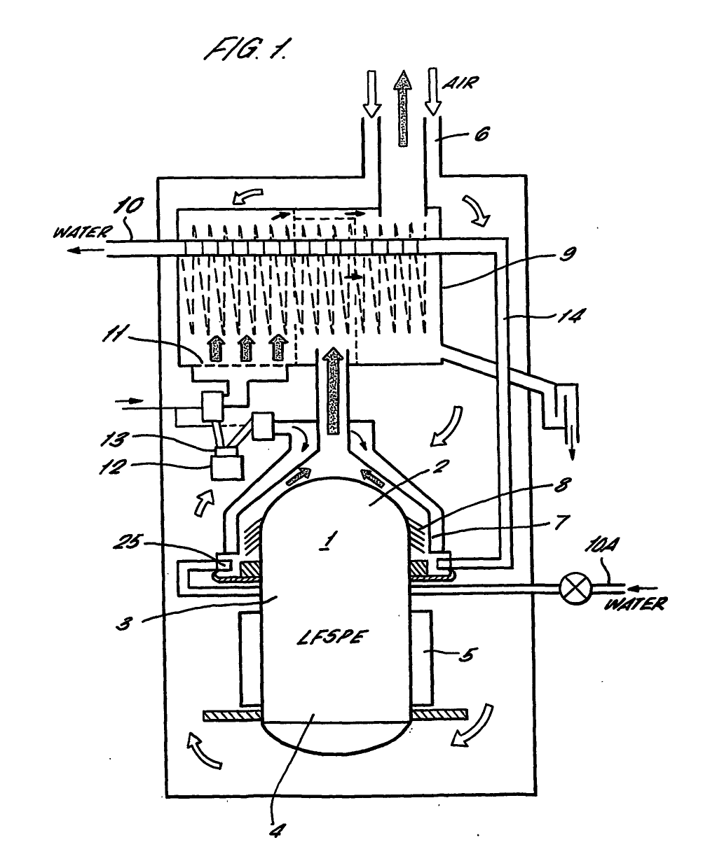

FIG. 1 is a schematic diagram of a first Stirling engine assembly;

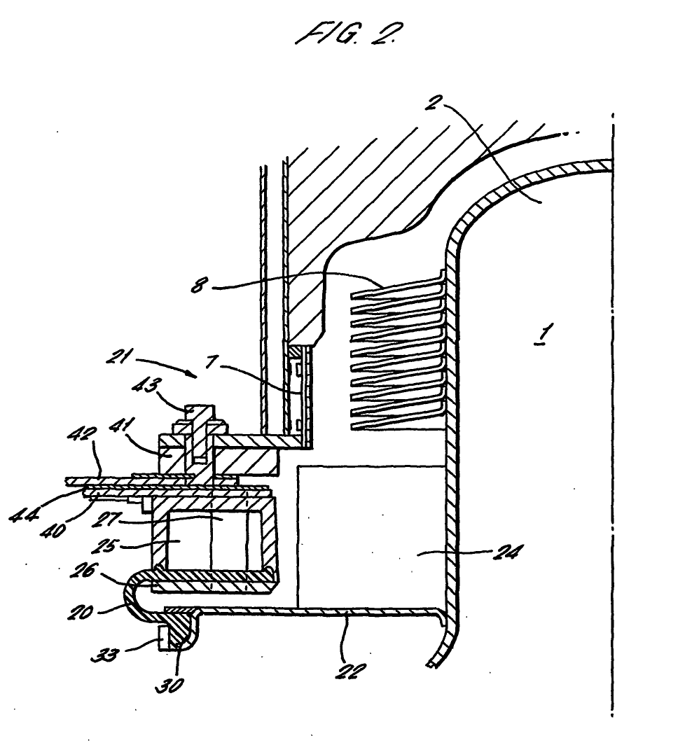

FIG. 2 is a cross-section showing a portion of the Stirling engine head and the combustion seal of the first engine;

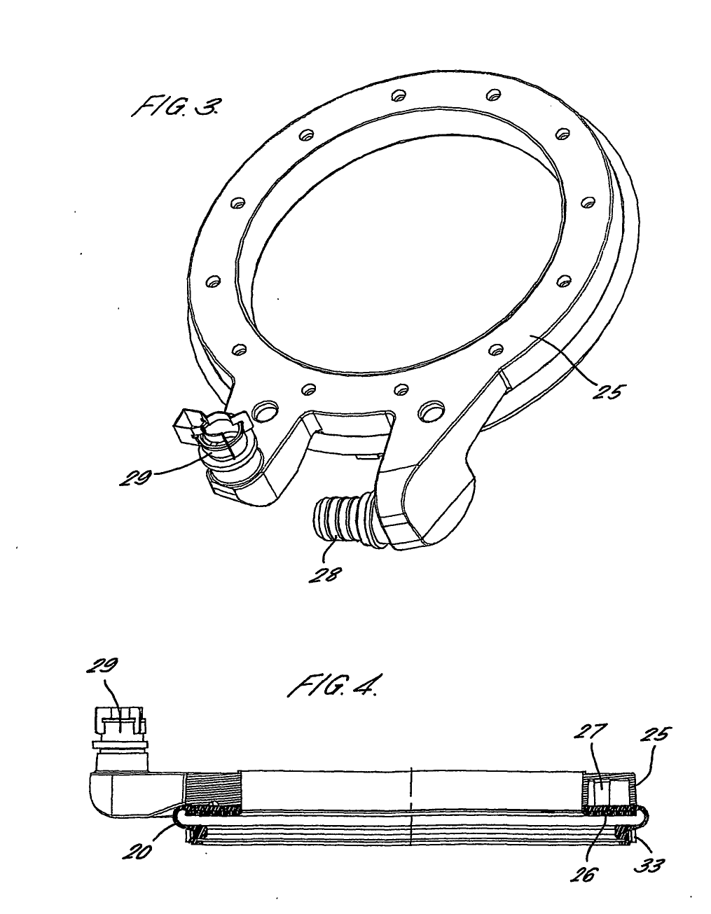

FIG. 3 is a perspective view of the liquid passage circuit of FIG. 2; and

FIG. 4 is a cross-section through the liquid coolant passage of FIG. 3.

Most aspects of the Stirling engine assembly shown in FIG. 1 are well known in the art and will be described only briefly here.

The Stirling engine 1 is a linear free piston Stirling engine and comprises an engine head 2 beneath which is a cooler 3 and an alternator 4. The Stirling engine 1 is suspended from a casing (not shown) by a plurality of springs 5.

Ambient air is drawn in through flue 6, preheated by combustion gases and mixed with combustible fuel before being ignited at burner 7 to heat the engine head 2. A plurality of fins 8 enhance the heat transfer to the head. Combustion gases preheat the incoming air/fuel mixture and are then fed to the heat exchanger 9 to heat water in a domestic central heating circuit 10. A supplementary burner 11 is provided to supply additional heat to the domestic central heating circuit 10 should the demand for hot water exceed that which can be supplied by the Stirling engine 1 alone. A fan 12 supplies the two burners 7, 11 and a splitter valve 13 controls the split of air between the burner 7 and supplementary burner 11. This, together with the control of the fan speed, allows control of the amount of air fed to each burner.

The hot water in the domestic central heating circuit 10 then circulates around the domestic central heating system where it loses its heat through the domestic radiators or it is used to meet the domestic hot water requirement. The cooled liquid then returns to the Stirling engine assembly along line 10A. It is known for this water to then be used to cool the engine cooler 3 resulting in a slight temperature rise in the water before returning to the heat exchanger 9 along line 14 to be heated to the full temperature required by the central heating system. The present invention operates in this way. However, it makes additional use of the incoming cool water in line 10A as described in greater detail below.

As shown in FIGS. 2 to 4, a seal 20 is provided to seal a space between burner casing 21 and an annular flange 22 welded to the head 2 of the Stirling engine 1. The coolant channel is provided by a cast aluminium channel element 25 having an inverted U cross-section. The seal 20 extends across the full width of the bottom of this channel element and is sandwiched between the bottom of the channel element 25 and an annular plate 26 which is held in place by a plurality of bolts 27. The channel has an inlet 28 and outlet 29. This arrangement of the seal and channel fulfils a number of functions. It provides a way of attaching the seal with respect to the burner casing, it provides a way of efficiently cooling the seal as a large part of the seal element is in direct contact with the water circulating in the channel 25, and it provides a way of sealing the channel without the need for a separate sealing element. The seal 20 is secured into an annular groove 30 by a seal retaining clip 33.

As well as the circulation of coolant fluid around the channel 25, there are a number of other measures which have been taken to reduce the temperature of the seal as will be apparent from FIG. 2. A ceramic insulation ring 24 which is made up of two semicircular pieces fills the majority of the space between the burner 7 and the cooling channel 25. The ring is also positioned so that there is a tortuous path from the burner to the seal 20. It will also be noted that the exposed part of the seal 20 is positioned radially outwardly of the channel 25, and is also exposed to the surrounding air. This allows cooling of the seal by the surrounding air, and also enhances the effect of the tortuous path referred to above.

In order to assemble the engine assembly, the engine is provided as a burner module and an engine module. The engine module includes the engine 1, the annular flange 22, the seal 20, the seal retaining clip 33, the cooling channel 25, annular plate 26, bolts 27 and an annular engine support bracket 40. It should be noted that the engine support bracket 40 extends beyond the extent shown in FIG. 2 and is independently supported, such that the weight of the channel 25 is supported through the engine support bracket 40 and not through the seal 20. The burner module includes the burner 7, and to this is attached an annular spacer 41 and an annular support bracket 42 via circumferentially arranged bolts 43. With the burner module in place, the engine module is inserted up into the burner module until the engine support bracket 40 abuts the main support bracket 42. The interface between these is sealed by a gasket 44.

In this example, the flow around the annular water jacket 25 is in series with the flow around the cooler 3. As shown in FIG. 1, the cool liquid in line 10A circulates around the cooler 3 in a known manner, before flowing along line 26 to the annular water jacket 25. The water leaving the annular water jacket 25 then travels along line 14 to the heat exchanger 9.

Water flows into the annular water jacket 25 from the Stirling engine cooler 3. Under normal operation, the temperature of the water is therefore in the region of 50° C. as it enters the jacket. Heat is removed from the burner housing 21, maintaining the seal material at an acceptable temperature. This allows the use of more effective sealing materials, which would degrade at the temperatures that would be encountered in the absence of cooling (potentially in excess of 350° C. housing temperature). Such sealing materials could be, for example, silicon rubber, or a fluoroelastomer such as Viton or PTFE.

In some circumstances the dwelling does not require heat, but the Stirling engine is operating to generate power. In such a situation, water will flow through Stirling engine cooler 3, around the seal, and heat exchanger 9, but then it will be routed through a bypass and flow back to the engine cooler without travelling around the domestic hot water system. The heat exchanger 9 will be operating to cool the water as no additional heat will be added here. Where supplementary burner 11 and Stirling engine burner 7 use separate fans, the supplementary burner fan could be operated to aid this heat removal as in patent application GB 0130378.3. Water temperatures within the cooling system will, however, be higher, usually up to 80° C., as no heat is being lost to the dwelling. Even at this temperature level the seal area will be adequately cooled, and no excessive material degradation will occur.

An additional benefit of the liquid cooled seal design is the recovery of additional heat into the cooling water. The heat transferred in this area would normally raise the temperature of the air inside the chp unit enclosure. Air is circulated around the enclosure by the forced draft as it is drawn into the air intake of the supplementary burner 11. Cooling for the external surfaces of the Stirling engine and the alternator 4 is required to maintain an acceptable temperature for internal components, and where the surrounding air is being heated around the seal area, this reduces the cooling effectiveness of the circulating air. By removing this heat in the water system, the air cooling the engine/alternator is at a lower temperature and therefore provides a more effective degree of cooling. This will extend the life of temperature-sensitive components such as the alternator magnets, and potentially also increase the generating efficiency of the alternator.

Although the engine is shown in the illustrated example, it could equally be applied to a non-vertical engine, such as a horizontal engine. It is also equally applicable to an engine mounted in an inverted configuration to that shown.

1. A Stirling engine assembly comprising a Stirling engine having a head, a burner for providing heat to the engine head, a flexible seal between the engine and burner, and a first liquid coolant circuit between the burner and seal positioned to reduce the heat transfer from the burner to the seal.

2. A Stirling engine assembly according to claim 1, wherein the Stirling engine further comprises a cooler with a second liquid coolant circuit fed with liquid common to the first liquid coolant circuit.

3. A Stirling engine assembly according to claim 2, wherein the first and second liquid coolant circuits are arranged in parallel.

4. A Stirling engine assembly according to claim 2, wherein the first and second liquid coolant circuits are arranged in series.

5. A Stirling engine assembly according to claim 1, wherein the first liquid coolant circuit is positioned radially inwardly of the seal.

6. A Stirling engine assembly according to claim 1, wherein in a torturous path is provided for gases flowing from the burner to the seal.

7. A Stirling engine assembly according to claim 1, wherein insulation is provided to reduce heat transfer from the burner to the seal.

8. A Stirling engine assembly according to claim 1, wherein fibrous insulating material is packed into the space beneath the burner between a burner housing and the head of the Stirling engine.

9. A Stirling engine assembly according to claim 1, wherein the seal is a silicon rubber sealing material.

10. A Stirling engine assembly according to claim 1, wherein the seal is a fluoroelastomer sealing material.

11. A Stirling engine assembly according to claim 1, wherein the seal can withstand a maximum temperature of less than 350° C.

12. A Stirling engine according to claim 1, wherein the flexible seal extends into the first liquid coolant circuit.

13. A Stirling engine according to claim 1, wherein the first liquid coolant circuit has, surrounding the engine, an open annular channel section and an annular plate across the open annular section, wherein the seal is sandwiched between the channel section and plate.
